(19) United States
(12) Patent Application Publication
(10) Pub. No.: US 2002/0121824 A1
(43) Pub. Date: Sep. 5, 2002

(54) Motor

(75) Inventor: Rikuro Obara, Nagano-ken (JP)

Correspondence Address: ISRAEL GOPSTEIN,Esq., Suite 200C, 14301 Layhill Rd., P.O. Box 9303, Silver Spring, MD, 20916-9303, US

(73) Assignee: Minebea Kabushiki-kaisha

(21) Appl. No.: 10/083,370

(22) Filed: Feb. 27, 2002

(30) Foreign Application Priority Data
Mar. 2, 2001 (JP) 2001-058151

(51) Int. Cl. H02K 5/16

(52) U.S. Cl. 310/90

(57) ABSTRACT

A motor of high precision in its rotation wherein the variation of the resonant frequency or the rotational run out due to thermal expansion of the component of the bearing device through the increasing temperature thereof is difficult to occur.

A motor having a rotating member 8 rotatably supported through a bearing device 5 on a base member 1 of the motor, said bearing device including a shaft 6, a cylindrical outer ring member 7 surrounding the shaft, and a plurality of balls 14a, 14b of the first and the second rows interposed between the shaft and the sleeve, the bearing device being characterized in that: the outer ring member includes upper and lower portions and a central portion therebetween, two rows of outer raceways 13a, 13b for the first and the second row of balls are formed on the inner peripheral surface of the upper and lower portions of the outer ring member, a squeeze member 16 of the same material as that used in forming the outer ring mar or of any other material of substantially the same coefficient of linear thermal expansion as that of the outer ring member is press fit around the outer periphery of the central portion of the outer ring member to elastically deform the outer ring member inwardly to form inwardly protruding squeezed portion 16.

### BACKGROUND OF THE INVENTION

1. Technical Field

The present invention relates to a motor suitable for office automation equipments such as a hard disk drive device of computers.

2. Description of the prior art

A motor for driving a magnetic disk or disks of a hard disk drive device of computers is structured for example as shown in FIG. 25. In FIG. 25, reference numeral 31 denotes a base member including a flange 31a and a stator yoke holder 32, reference numeral 33 denotes a coil or coils, reference numeral 34 denotes a stator yoke or yokes, reference numeral 35 denotes a rotor, reference numeral 36 denotes a central sleeve of a hub of the rotor, and reference numeral 37 denotes a rotor magnet or magnets. Also included in the motor is a bearing device 40 including a shaft 41 secured at its lower end on the central portion of the stator yoke holder 32 of the base member 31. The rotor hub 35 or rotating member is rotatably supported through the bearing device.

The bearing device 40 employed in the motor includes as shown magnified in FIG. 26 upper and lower ball bearings 42, 43 having inner rings 42a, 43a fit and attached to a shaft 41 and outer rings 42b, 43b fit within a sleeve 44. In FIG. 26, reference numeral 42c, 43c denotes balls, reference numeral 45 denotes ball retainers, and reference numeral 46 denotes a spacer.

Upon rising the temperature of the bearing device under the effect of the frictional heat generated by the rotation or operation of the motor or the effect of heat energy supplied from the outside of the bearing device, thermal expansion of the components of the bearing device will be caused differently. In the case of the ball bearings 42, 43, the order of the amount of expansion in the diametrical direction of the components is that the outer ring>the inner ring>balls.

In other words, although the spacing between the inner and outer raceways of the inner and outer rings will increase upon rising the temperature of the motor, the amount of the increased spacing is larger than the amount of expansion of the balls so that the pressure applied by the inner and outer raceways of the inner and outer rings on the balls i.e. the pre-load is reduced. This will deteriorate the precision of the rotation of the bearing device and vary the resonant frequency thereof upon rotating of the bearing device, and in some cases causes harmonic oscillation with the motor or the other components of the equipment into which the motor is incorporated.

When the motor of the prior art of the above described structure is used for driving the hard disk drive device, the accuracy of writing or reading out the data is often deteriorated by the vibration of the drive device caused by the resonance with other components such as a swing arm or a casing. There is also a possibility for generating noises caused by the vibration, and affecting the quietness of the drive device.

In case the difference of the thermal expansion between the inner and outer ring is further increased, the clearance between the balls and the raceways of the inner and outer ring increases causing rotational run out of the rotor with which the magnetic disk or disks are assembled and run out of the surface of the magnetic disk or disks, deteriorating reliability of the hard disk drive device.

Although the balls are usually formed of steel material, ceramic material may also be used for enhancing the durability thereof. In such a case, the above mentioned problem caused by the difference of the amount of thermal expansion between components will become serious, since the amount of thermal expansion of the ceramic material is further lower (approximately 1/10) than that of the steel material.

Accordingly the object of the present invention is to provide a motor wherein appropriate pre-load can be applied constantly to the balls even if the components of the bearing device expand by rising the temperature thereof. In other words, the object of the present invention is to provide a motor of high precision in its rotation wherein the variation of the resonant frequency or the rotational run out due to temperature variation are difficult to occur.

### SUMMARY OF THE INVENTION

In order to attain the object of the present invention, a motor in accordance with the first aspect of the present invention comprises a rotating member rotatably supported through a bearing device on a base member of the motor, said bearing device including a shaft, a cylindrical outer ring member surrounding the shaft, and a plurality of balls of the first and the second rows interposed between the shaft and the outer ring member, the bearing device characterized in that:

the outer ring member includes upper and lower portions and a central portion therebetween,

two rows of outer raceways for the first and the second row of balls are formed on the inner peripheral surface of the upper and lower portions of the outer ring member,

a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion.

A motor in accordance with the second aspect of the present invention including a rotating member rotatably supported through a bearing device on a base member of the motor, said bearing device including a shaft to which an inner ring is fit slidably, a cylindrical outer ring member surrounding the shaft, a plurality of balls of the first row interposed between the first inner raceway formed on the outer periphery of the inner ring and the first outer raceway formed on the inner periphery of the outer ring member, a plurality of balls of the second row interposed between the second inner raceway formed directly on the outer periphery of the shaft and the second outer raceway formed on the inner periphery of the outer ring member, the bearing device being characterized in that:

the outer ring mover includes upper and lower portions on the inner periphery of which is provided with the first and the second outer raceways respectively and a central portion therebetween,

a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,

wherein the inner ring is secured to the shaft with applying an appropriate reload thereon.

A motor in accordance with the third aspect of the present invention including a rotating member rotatably supported through a bearing device on a base member of the motor, said bearing device including a shaft, a cylindrical outer ring member surrounding the shaft, and a plurality of balls of the first and the second rows interposed between the shaft and the outer ring member, the bearing device being characterized in that:

the outer ring member includes upper and lower portions and a central portion therebetween,

two rows of outer raceways for the first and the second row of balls are formed on the inner peripheral surface of the upper and lower portions of the outer ring member,

a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,

wherein the shaft is secured on the base member to extend therefrom, and the central portion of the rotor or the rotating member is fit over the outer periphery of the outer ring member.

A motor in accordance with the fourth aspect of the present invention including a rotating member rotatably supported through a bearing device on a base member of the motor, said bearing device including a shaft, an inner ring fit slidably around the shaft, and a cylindrical outer ring member surrounding the shaft, a plurality of balls of the first row interposed between the first inner raceway formed on the outer periphery of the inner ring and the first outer raceway formed on the inner periphery of the outer ring member, and a plurality of balls of the second row interposed between the second inner raceway formed directly on the outer periphery of the shaft and the second outer raceway formed on the inner periphery of the outer ring member, the bearing device being characterized in that:

the outer ring member includes upper and lower portions on the inner periphery of which is provided with the first and the second outer raceways respectively and a central portion therebetween,

a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,

wherein the shaft is secured on the base member to extend therefrom, and the central portion of the rotor or the rotating member is fit over the outer periphery of the outer ring member. The balls are preferably of ceramic material.

In the motor of another embodiment in accordance with the present invention, a thin walled reduced outer diameter portion is forced around the outer periphery of the central portion of the outer ring member of the bearing device, and the squeeze member is press fit around the reduced outer diameter portion.

In the motor of the other embodiment in accordance with the present invention, the outer ring member of the bearing device includes the first and the second sleeve outer rings adjacent axially with each other, each of the first and the second outer raceways is formed on the inner surface of the first and the second sleeve outer rings respectively, thin walled reduced outer diameter stepped portions are formed around adjacent end portions of the first and the second sleeve outer rings, and the squeeze member is press fit around the reduced outer diameter stepped portions.

In the motor of further embodiment in accordance with the present invention, the outer ring member of the bearing device includes the first and the second sleeve outer rings adjacent axially with each other, each of the first and the second outer raceways is formed on the inner surface of the first and the second sleeve outer rings respectively, thin walled reduced outer diameter stepped portions are formed around adjacent end portions of the first and the second sleeve outer rings, and each of the first and the second squeeze members is press fit around the reduced outer diameter stepped portions respectively.

In the motor of further embodiment in accordance with the present invention, the squeeze member of the bearing device is a cylindrical body formed on the inner periphery of which with a thick walled reduced inner diameter portion having an inner dieter smaller than the outer diameter of the outer ring member, an axial width of the thick walled portion is smaller than the spacing between two rows of outer raceways, and the outer ring member is pressed by the reduced inner diameter portion of the cylindrical body.

### BRIEF DESCRIPTION OF THE DRAWINGS

Further feature of the present invention will become apparent to those skilled in the art to which the present invention relates from reading the following specification with reference to the accompanying drawings, in which:

FIG. 1 is a vertical sectional view showing the motor in accordance with the first embodiment of the present invention;

FIG. 2 is an enlarged vertical sectional view showing the bearing device of FIG. 1;

FIG. 3 is a vertical sectional view showing the motor in accordance with the second embodiment of the present invention;

FIG. 4 is an enlarged vertical sectional view showing the bearing device of FIG. 3;

FIG. 5 is a vertical sectional view showing the motor in accordance with the third embodiment of the present invention;

FIG. 6 is an enlarged vertical sectional view showing the bearing device of FIG. 5;

FIG. 7 is a vertical sectional view showing the motor in accordance with the fourth embodiment of the present invention;

FIG. 8 is an enlarged vertical sectional view showing the bearing device of FIG. 7;

FIG. 9 is a vertical sectional view showing the motor in accordance with the fifth embodiment of the present invention;

FIG. 10 is an enlarged vertical sectional view showing the bearing device of FIG. 9;

FIG. 11 is a vertical sectional view showing the motor in accordance with the sixth embodiment of the present invention;

FIG. 12 is an enlarged vertical sectional view showing the beating device of FIG. 11;

FIG. 13 is a vertical sectional view showing the motor in accordance with the seventh embodiment of the present invention;

FIG. 14 is an enlarged vertical sectional view showing the bearing device of FIG. 13;

FIG. 15 is a vertical sectional view showing the motor in accordance with the eighth embodiment of the present invention;

FIG. 16 is an enlarged vertical sectional view showing the bearing device of FIG. 15;

FIG. 17 is a vertical sectional view showing the motor in accordance with the ninth embodiment of the present invention;

FIG. 18 is an enlarged vertical sectional view showing the bearing device of FIG. 17;

FIG. 19 is a vertical sectional view showing the motor in accordance with the tenth embodiment of the present invention;

FIG. 20 is an enlarged vertical sectional view showing the bearing device of FIG. 19;

FIG. 21 is a vertical sectional view showing the motor in accordance with the eleventh embodiment of the present invention;

FIG. 22 is an enlarged vertical sectional view showing the bearing device of FIG. 21;

FIG. 23 is a vertical sectional view showing the motor in accordance with the twelfth embodiment of the present invention;

FIG. 24 is an enlarged vertical sectional view showing the bearing device of FIG. 23;

FIG. 25 is a vertical sectional view showing the motor in accordance with the prior art; and

FIG. 26 is an enlarged vertical sectional view showing the bearing device of FIG. 25;

### DETAILED DESCRIPTION OF THE PRESENT INVENTION

A motor in accordance with an embodiment of the present invention will now be described in detail with reference to the attached drawings.3

A motor of the first embodiment of the present invention includes a base member 1 having a flange 1a and a stator yoke holder 2 attached to the central portion of the flange. The stator yoke holder 2 includes a bottom plate 2a and a cylindrical rib 2b formed integrally therewith. The cylindrical rib 2b is provided around the outer periphery thereof with stator yokes 4 around which a coil 3 for energizing the motor is wound.

A shaft 6 of the bearing device 5 to be referred herein below is fixedly secured on the central portion of the bottom plate 2a of the stator yoke holder 2 to extend upwardly therefrom. A sleeve 9 formed integrally with a rotor 8 and of the same material as that of the rotor is fit around a sleeve 7 of the bearing device 5. The rotor or the rotating member of the motor can thus be rotatably supported through the bearing device with respect to the base member 1.

A downward flange 8a formed around the outer peripheral portion of the rotor 8 is provided on its inner periphery with magnets 10 so as to face with the outer periphery of the stator yoke with a slight clearance between them.

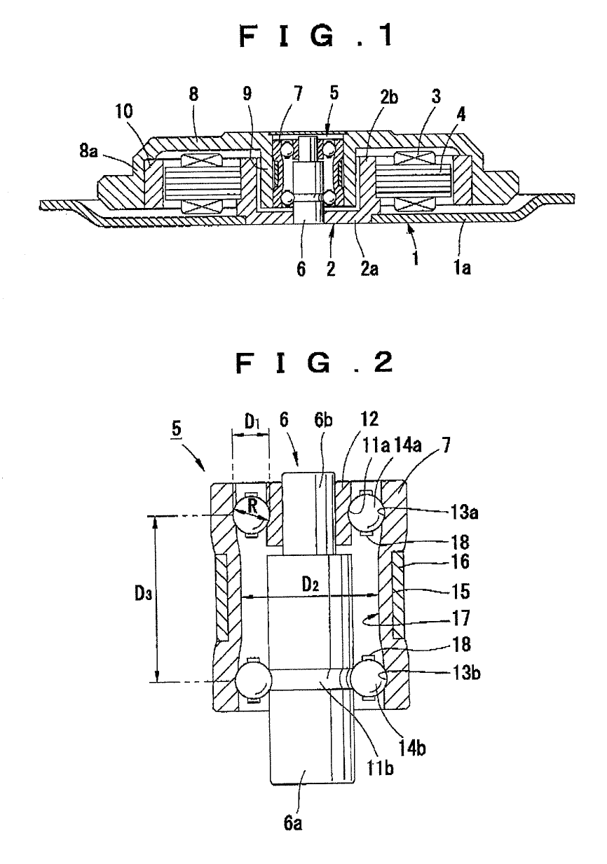

The bearing device 5 of the motor in accordance with the present invention is a compound bearing device of unique structure as shown in the enlarged cross sectional view of FIG. 2. The compound bearing device 5 comprise a stepped shaft 6 including a larger diameter shaft portion 6a and a reduced diameter shaft portion 6b, a sleeve 7 surrounding the stepped shaft 6, and an inner ring 12 fit around the reduced diameter shaft portion 6b of the stepped shaft. The inner ring 12 has the first inner raceway 11a or groove formed therearound. The larger diameter shaft portion 6a has the second inner raceway 11b or groove formed directly around the outer periphery thereof.

The sleeve 7 includes a pair of parallel first and second outer raceways 13a and 13b or grooves formed directly on the inner peripheral surface thereof. The sleeve outer ring 7 is adapted to serve as an outer ring in ,common with both rows. A plurality of balls 14a for the first row are interposed between the first outer raceway 13a and the first inner raceway 11a, and a plurality of balls 14b for the second row are interposed between the second outer raceway 13b and the second inner raceway 11b.

The balls 14a and 14b are made for example of ceramic material and have the same diameter. This is because the outer diameter of the inner ring 12 is the same as that of the larger diameter shaft portion 6a of the stepped shaft.

A thin walled reduced outer diameter portion 15 is formed on the outer periphery of the central portion of the sleeve 7 between the first and the second outer raceways 13a and 13b. A squeeze ring 16 is adapted to be press fit into the reduced outer diameter portion 15. The squeeze ring or squeeze member may be formed of a material of substantially the same coefficient of linear thermal expansion as that of the sleeve such as iron material or aluminum material.

The squeeze ring 16 is smaller in its inner diameter than the outer diameter of the reduced outer diameter portion 15 before assembling the ring therearound. The assembling operation of the ring on the reduced outer diameter portion 15 is effected by the shrink-fit technique. The outer diameter of the squeeze ring 16 is the same as that of the upper and lower larger outer diameter portion of the sleeve.

When press fitting the squeeze ring 16 around the reduced outer diameter portion 15 of the sleeve 7, the sleeve 7 is squeezed or pressed inwardly to form on the inner peripheral surface of the central portion thereof a squeezed portion 17 protruding inwardly under the effect of the elastic deformation of the sleeve.

The inner diameter of the squeeze ring 16 may vary in accordance with the material employed for the sleeve 7 and the threshold value of the increased temperature upon used the motor. The amount of deformation of the squeezed portion 17 formed around the sleeve 7 should be within the elastic limit of the material of the sleeve. The reference numeral 18 denotes each ball retainer.

When it is intended to assemble the bearing device of the arrangement as described above, the sizing ring 16 is at first press fit around the reduced outer diameter portion 15 of the sleeve 7 by employing the shrink-fit technique to deform the sleeve inwardly to form the squeezed portion 17 on the inner peripheral surface of the sleeve.

Thus the first and the second outer raceways of the sleeve outer ring 7 are drawn toward the squeezed portion 17 to reduce the longitudinal spacing D₃ therebetween relative to the condition before press fit the squeezing ring 16.

The spacing D₃ between the outer raceways after the press fitting of the squeezing ring is designed to be increased in accordance with thermal expansion of the sleeve due to the increased temperature of the motor. When the sleeve reaches the predetermined temperature, for example the anticipated maximum temperature of the running motor, the spacing between the outer raceways is enlarged to the degree before press fitting the squeeze ring.

Subsequently, the inner ring 12 is fit slidably around the reduced diameter shaft portion 6b of the stepped shaft 6, the sleeve 7 and the balls 14a, 14b of the first and second rows are assembled therearound, and then the inner ring 12 is secured on the reduced diameter shaft portion 6b by any means such as an adhesive with applying an appropriate pre-load on the upper end surface of the inner ring 12. Thus the compound bearing is completed.

The temperature of bearing device will rise under the effect of the frictional heat generated by the rotation or operation of the motor thereof, or the effect of heat energy supplied from the outside of the bearing device. When the temperature rises, thermal expansion of each component of the bearing device will be caused. The amount of thermal expansion of the sleeve 7 in the diametric direction is larger than that of the inner ring 12 and/or the stepped shaft 6.

Consequently, the spacing D₁ between each of the first and second inner raceways and the outer raceway will increase upon rising the temperature. In this connection, the bearing device is deformed to reduce the load applied by the raceways on the balls 14a, 14b through the contact therewith. This is because the amount of thermal expansion of the diameter R of the balls is smaller than that of the inner ring 12 and/or the stepped shaft and the sleeve.

On the other hand, the average diameter of the squeezing ring 16 is larger than that of the sleeve 7 so that upon rising the temperature of the bearing device, the squeeze ring expands to the amount larger than that of the sleeve, the pressure applied by the squeezing ring 16 on the sleeve 7 will be reduced, and the sleeve 7 tend to retrieve its original straight cylindrical configuration under the effect of elastic recovering force, i. e. the inner diameter D₂ of the squeezed portion 17 is increased, i.e. the amount of protrusion thereof is decreased to extend the sleeve in axial direction. In other words, the sleeve itself extends axially under the effect of thermal expansion and the longitudinal spacing D₃ between the first and the second outer raceways 13a and 13b is also increased, so that the bearing device is deformed generally to increase the pre-load.

In conclusion, the reduction of the pre-load on the balls due to the enlargement of the spacing D₁ between each of the first and second inner raceways of the first and second ball rows and the outer raceway will be offset by the augmentation of the pre-load on the balls due to the enlargement of the longitudinal spacing D₃ between the first and the second outer raceways. Thus an appropriate pre-load can be maintained even if the temperature of the device rises.

In the above mentioned bearing device of the motor of the first embodiment, the sleeve 7 serves as an outer ring in common with both of the upper and lower rows so that the number of parts can be reduced, the diameter of the larger diameter shaft portion 6a can be enlarged by the sum of the thicknesses of the inner and the outer rings of the ball bearing, and the diameter of the reduced diameter shaft portion 6b can also be enlarged by the thickness of the outer ring of the ball bearing, i.e. generally thick shaft 6 can be obtained.

Accordingly, the steed shaft 6 of higher rigidity, good at durability, inhibited in its rotational run out, and good at quietness can be obtained. Thus the durability and the accuracy of rotation of the motor can also be improved.

The motor of the present invention has its primary feature in the structure of the bearing device as described above. In this connection, different embodiments of the motor including bearing device of various structures will now be described hereinbelow.

In each embodiment described as follows, the structure of the motor is substantially identical with that of the first embodiment except for the bearing device, so that the any further descriptions on the structure of the motor itself are omitted.

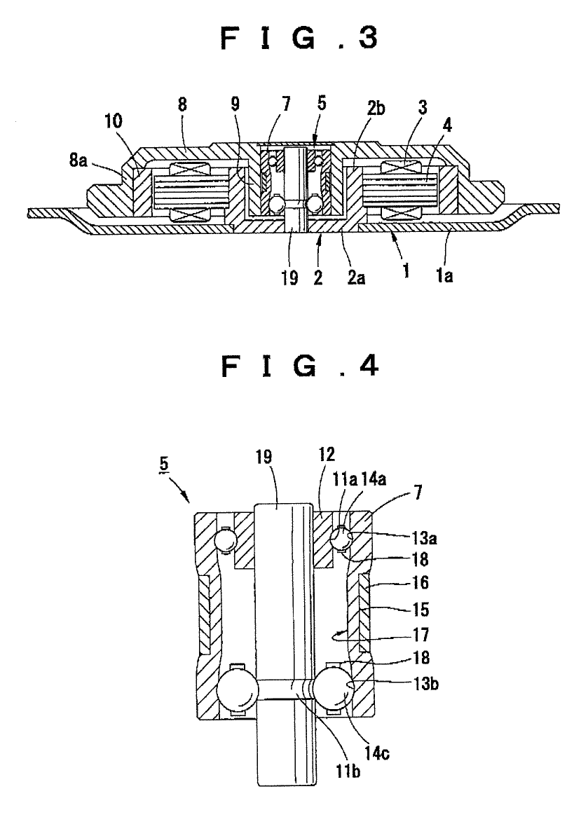

In the bearing device of the motor of the first embodiment as described above, the shaft is formed as the stepped shaft 6. Whereas the shaft con be a straight one 19 as that of the second embodiment as shown in FIGS. 3 and 4.

The bearing device of the motor of the second embodiment is also provided with the inner ring 12 on the side of the first row of balls 14a (i.e. the upper side in FIGS. 3 and 4). Whereas no inner ring is provided on the side of the second row of balls 14c (i.e. the lower side in FIGS. 3 and 4), and the second inner raceway 11b is formed directly on the outer peripheral surface of the straight shaft 19.

Thus the balls 14c of the second row are larger in their diameter than that of the balls 14a of the first row.

The bearing device of the motor of the second embodiment is substantially identical with that of the first embodiment except for the arrangement of the shaft and the balls of the second row.

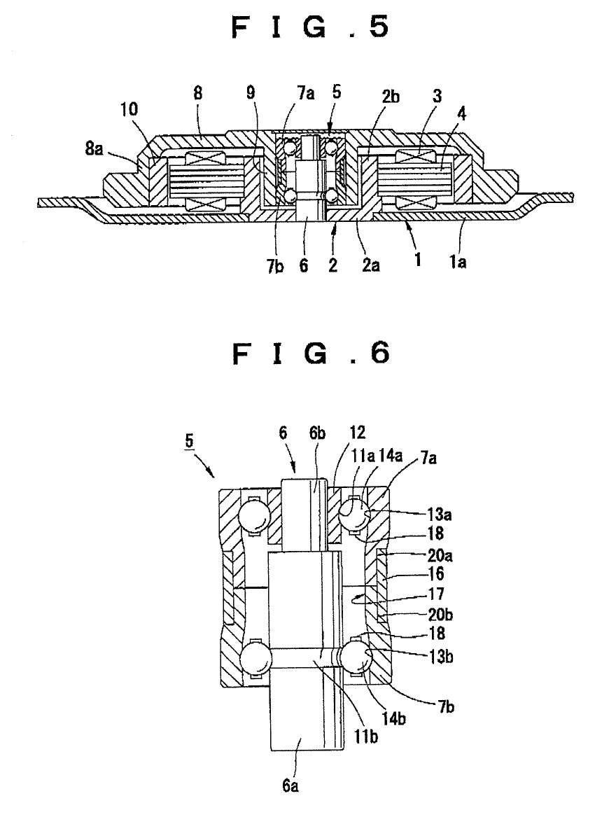

The motor of the first and the second embodiments have the sleeve 7 serving as one common outer ring member having on its inner surface the outer raceways 13a, 13b of the two rows. Whereas, the outer ring can be divided into an upper first sleeve outer ring 7a and a lower second sleeve outer ring 7b as the third to the sixth embodiments as shown in FIGS. 5 to 12.

In the third and the fourth embodiments, each of the first and the second sleeve outer rings 7a and 7b is formed with reduced outer diameter stepped portions 20a, 20b respectively on their ends adjacent with each other. The end faces of these reduced outer diameter stepped portions are machined in high precision to contact intimately with each other. The squeeze ring 16 is adapted to be press fit around the outer periphery of the reduced outer diameter portions 20a, 20b.

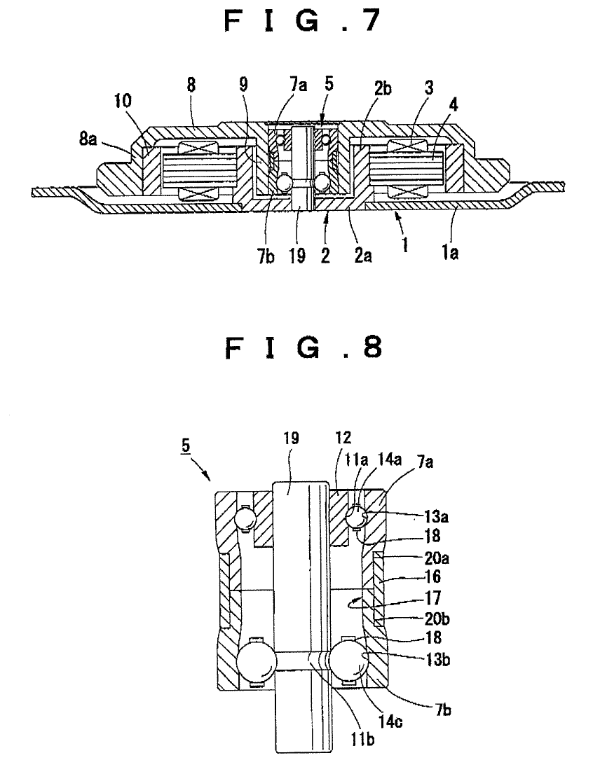

The bearing device of the fourth embodiment as shown in FIGS. 7 and 8 is arranged to substitute the straight shaft 19 for the stepped shaft 6 of the third embodiment shown in FIGS. 5 and 6, and the components or arrangements other than the shaft and the balls of the second row are identical with those of the third embodiment.

In the bearing device of the fifth and the sixth embodiments, each of the thin walled reduced outer diameter stepped portions 20a, 20b are formed respectively on the ends of the first and the second sleeve outer rings 7a and 7b adjacent with each other. The end faces of these reduced outer diameter stepped portions are machined in high precision to contact intimately with each other. Each of the first and the second squeeze rings 16a, 16b is adapted to be press fit respectively around the outer periphery of each of the reduced outer diameter portions 20a, 20b.

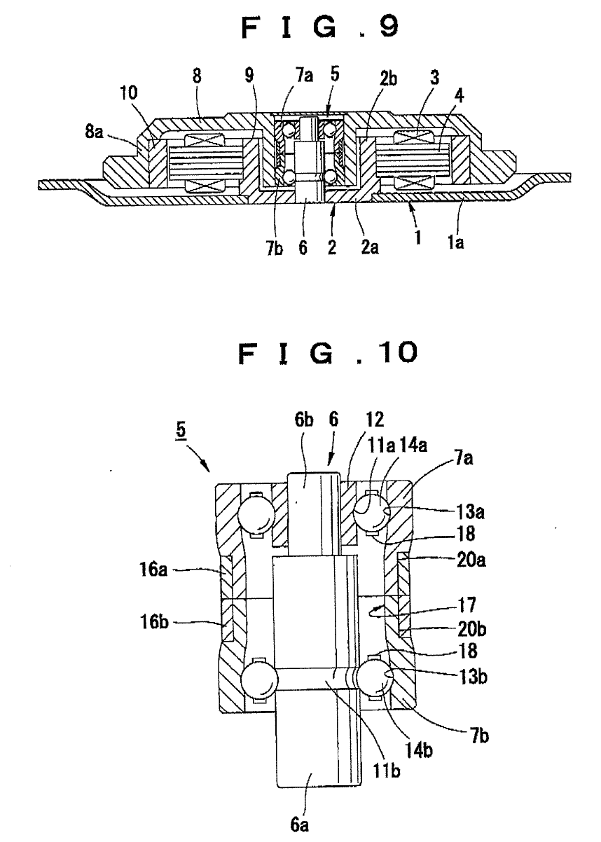

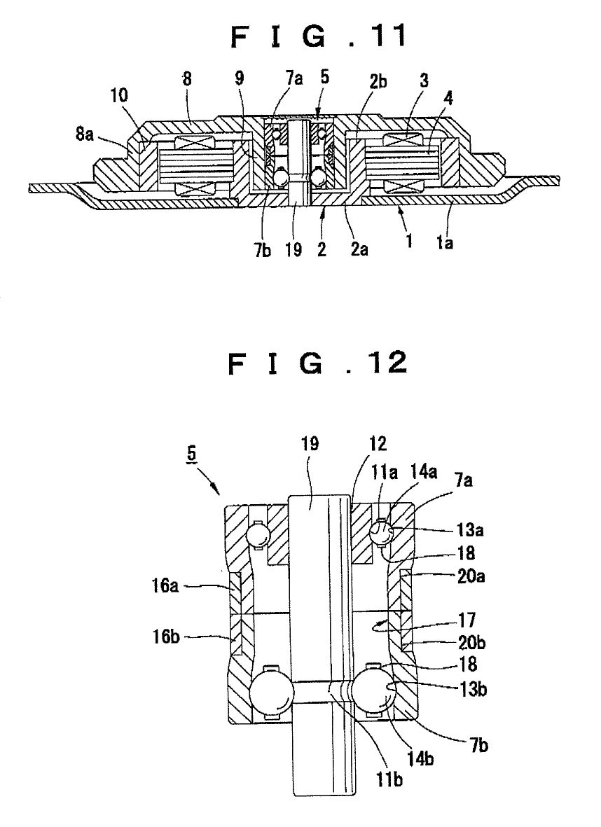

The bearing device of the sixth embodiment as shown in FIGS. 11 and 12 is arranged to substitute the straight shaft 19 for the stepped shaft 6 of the fifth embodiment shown in FIGS. 9 and 10, and the components or arrangements other than the shaft and the balls of the second row are identical with those of the fifth embodiment.

In the bearing device of the third to sixth embodiments, the press fitting operation of the squeeze ring 16 or the rings 16a, and 16b around the reduced outer diameter portions 20a, 20b of the sleeve outer ring can be effected easier than those effected on the first and second embodiments, since the sleeve outer rings 7a and 7b of these embodiments are divided or separated into the upper and lower outer rings.

In the motor of the above described first and second embodiments the sleeve 7 serving as one common outer ring member of the bearing device includes a pair of outer raceways formed thereon. It is difficult to machine these two outer raceways with assuring the concentricity and/or parallelism between the raceways in high precision. This machining operation is particularly difficult where the balls of the first row are spaced relatively larger from those of the second row. Whereas in the bearing device of the motor of the third to the sixth embodiments the machining operation of the outer raceways in high precision can relatively easily be carried out. This is because the sleeve is separated into two sleeve outer rings 7a, 7b, and the machining operation may be carried out in each of these sleeve outer rings. In other words, the raceways can easily be machined in high precision. This will bring the great advantage that the raceways can easily be machined in high precision even if the spacing between the balls of the first row and those of the second row is relatively large.

In the bearing device of the motor of the third to the sixth embodiments, the outer diameter of the squeeze ring 16 or the rings 16a, and 16b is identical with that of the upper and lower larger outer diameter portions of the sleeve outer ring 7 or the rings 7a, 7b in the same manner as those of the first and the second embodiments.

In the motor of the above-described first to the sixth embodiments, the bearing device is formed straight on its outer diameter, so that the sleeve of the bearing device can easily be assembled into the sleeve of the rotor without requiring any special machining operation.

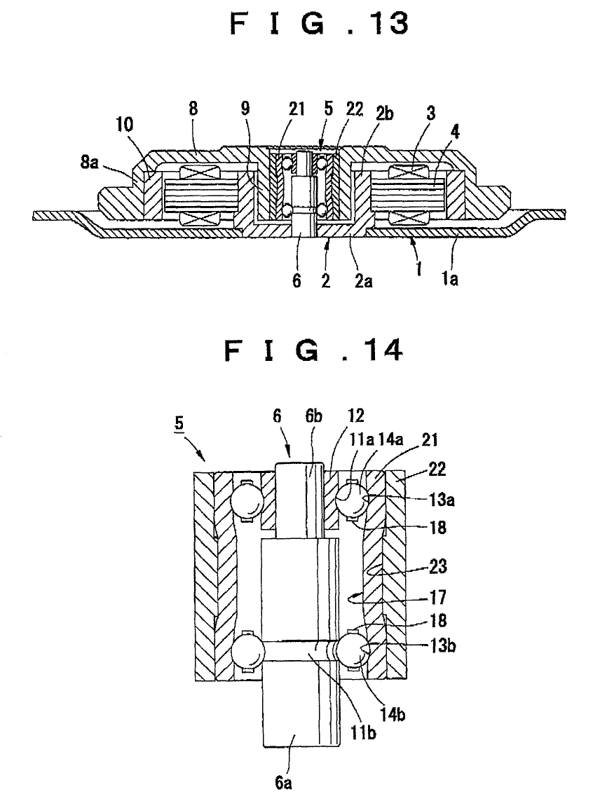

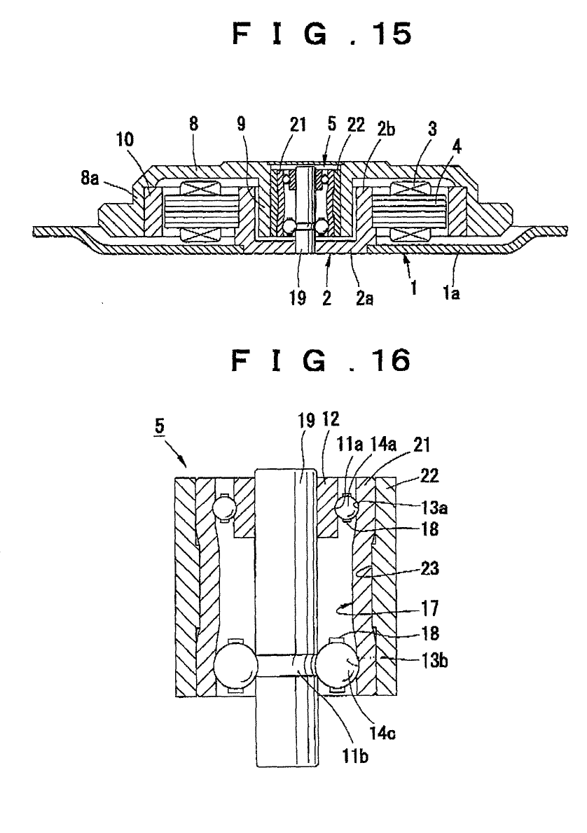

In the motor of the above described the first to the sixth embodiments, the thin walled reduced outer diameter portion 15 or the reduced outer diameter stepped portions 20a, 20b is formed around the sleeve of the bearing, device and the squeeze ring 16 or the rings 16a, and 16b is press fit thereto. Whereas in the motor of the seventh embodiment shown in FIGS. 13 and 14, and the eighth embodiment shown in FIGS. 15 and 16, a sleeve 21 of the straight cylindrical configuration having no stepped portion around the outer peripheral surface thereof can also be used. A cylindrical body 22 or squeeze member may be mounted and the outer periphery of the sleeve 21.

Each of the cylindrical body 22 of the seventh and the eighth embodiments has a straight cylindrical configuration having an outer periphery of a constant diameter in the axial direction. The cylindrical body 22 has on its inner peripheral surface upper and lower larger inner diameter portions and a thick walled reduced inner diameter portion 23 therebetween.

The inner diameter of the upper and lower larger inner diameter portions of the cylindrical body 22 is larger than the outer diameter of the sleeve so that a slight gap is formed between each larger inner diameter portion and the outer peripheral surface of the sleeve. Whereas the inner diameter of the reduced inner diameter portion 23 is smaller than the outer diameter of the sleeve 21 so that the sleeve 21 is adapted to be pressed inwardly by the reduced inner diameter portion 23. Thus the sleeve is deformed elastically under the influence of the urging force to form the squeezed portion 17 protruding inwardly on the inner surface thereof between the first and the second outer raceways 13a, 13b.

The inner diameter of the reduced inner diameter portion 23 is determined on the basis of the materials employed for the sleeve 21 and the threshold value of the increased temperature upon used the motor. The amount of deformation of the squeezed portion 17 formed around the sleeve 21 should be within the elastic limit of the material of the sleeve.

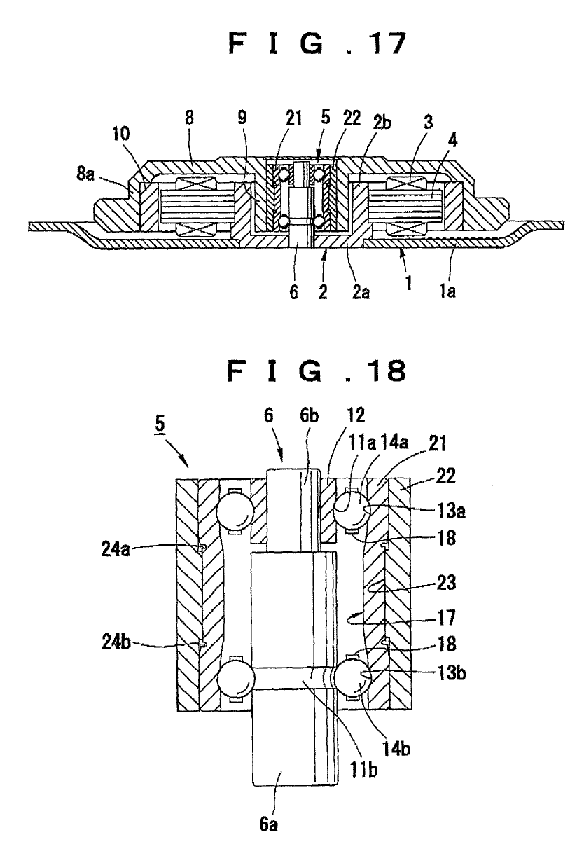

The motor of the ninth to the twelfth embodiments as show in FIGS. 17 to 24 are devised to facilitate the initial deformation of the sleeve 21 of the bearing device of the seventh and the eighth embodiments as described above.

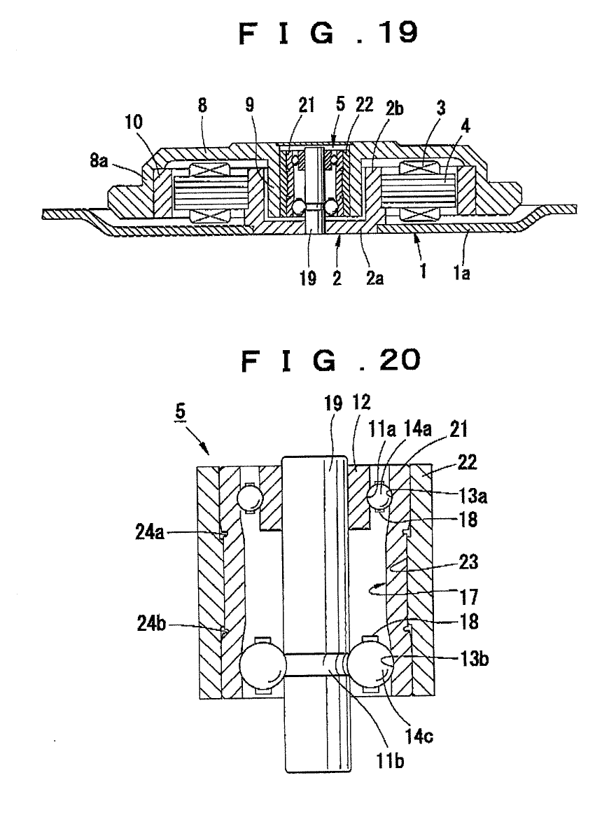

In the motor of the ninth embodiment as shown in FIGS. 17 and 18, and the motor of the tenth embodiment as shown in FIGS. 19 and 20, the sleeve 21 can be divided into upper and lower portions on the inner surface of which is provided with the first and the second outer raceways 13a, 13b respectively and one central portion interposed between the upper and lower portions. The sleeve 21 is provided on the outer peripheral surface of the central portion thereof with a pair of parallel peripheral grooves 24a, 24b of the spacing therebetween larger than the width of the reduced inner diameter portion 23 of the cylindrical body 22.

In the bearing device of the motor of the ninth and the tenth embodiments, the central portion of the sleeve formed between the peripheral grooves 24a, 24b is pressed by the reduced inner diameter portion 23 of the cylindrical body 22 to deform inwardly to form the squeezed portion 17.

The bearing device of the motor of the tenth embodiment as shown in FIGS. 19 and 20 is arranged to substitute the straight shaft 19 for the stepped shaft 6 of the ninth embodiment shown in FIG. 17 and 18, and the components or the arrangements other than the shaft and the balls of the second row are identical with those of the ninth embodiment.

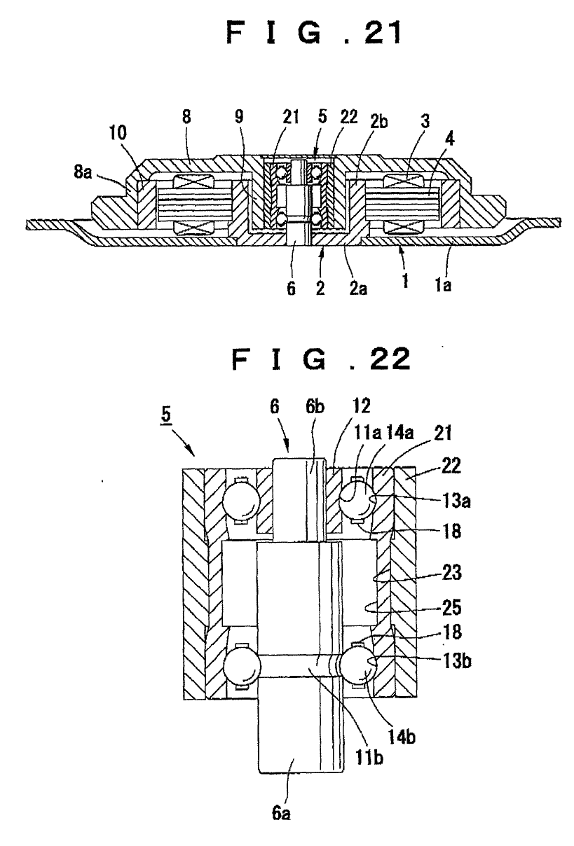

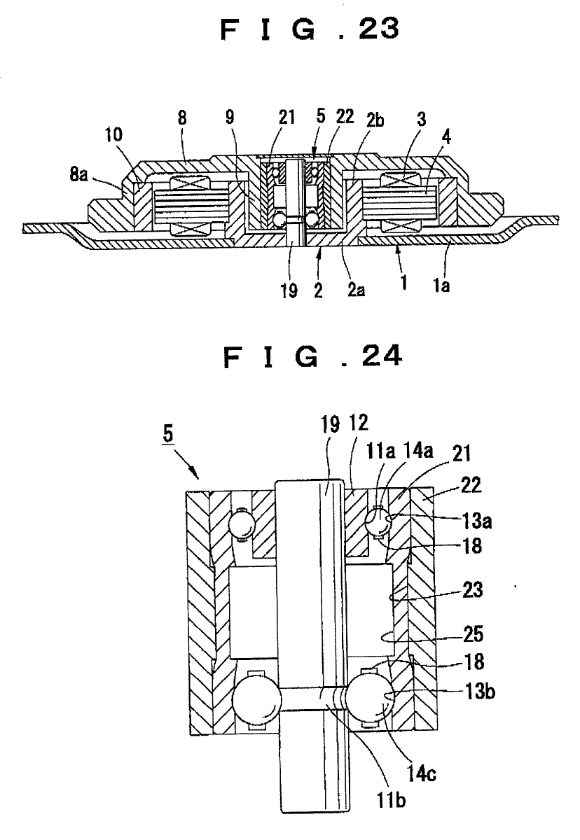

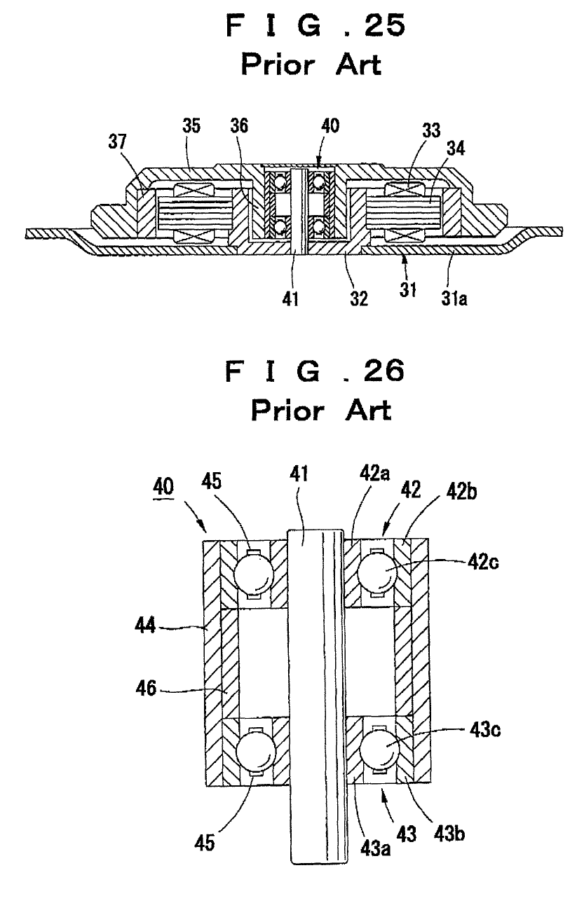

In the bearing device of the motor of the eleventh embodiment as shown in FIGS. 21 and 22 and the motor of the twelfth embodiment as shown in FIGS. 23 and 24, the sleeve 21 includes upper and lower portions and a central portion interposed therebetween. Each of the upper and lower portions of the sleeve 21 are provided on their inner peripheral surfaces with the first and the second outer raceways 13a, 13b respectively. The central portion of the sleeve outer ring is provided on its inner peripheral surface a larger inner diameter portion 25 of the axial width substantially identical with that of the reduced inner diameter portion 23 of the cylindrical body 22.

The sleeve 21 of the bearing device of the motor of the eleventh or twelfth embodiment is adapted to be deformed around the larger inner diameter portion 25 inwardly under the influence of the urging force applied by the reduced inner diameter portion 23 of the cylindrical body 22 from the outer side of the outer ring 21.

The bearing device of the motor of the twelfth embodiment as shown in FIGS. 23 and 24 is arranged to substitute the straight shaft 19 for the stepped shaft 6 of the eleventh embodiment shown in FIG. 21 and 22, and the components or the arrangements other than the shaft and the balls of the second row are identical with those of the eleventh embodiment.

Although the balls used in each embodiment as described above are formed of ceramic material to enhance the durability thereof, steel or any other materials may be used therefor.

The motors of above-mentioned embodiments are all of the outer rotor type in which the shaft of the motor is stational. However, the motor of shaft rotating type in which the sleeve outer ring or the outer ring member of the compound bearing device is connected to the side of the base member, and the rotating member is connected to the shaft can also be used. Further, a motor of the inner rotor type in which the rotor magnets are provided on the inside of the stator yoke can also be used.

The motor of the arrangement or the structure as described above in accordance with the present invention will present the following effects or advantages.

The squeeze member presses inwardly the central portion of the outer ring member surrounding the shaft to form a squeezed portion, so that upon rising the temperature of the motor, the components of the bearing device will expand to enlarge the spacing between the inner and outer raceways. On the other hand, the outer ring member extends under the effect of elastic recovering force and thermal expansion in the axial direction to enlarge the axial spacing between the first and the second outer raceways. Thus the load to be applied to the balls through the contact with the inner and outer raceways i.e. the pre-load applied on the balls are maintained in a predetermined value.

Consequently, the accuracy of the rotation of the bearing device can be kept constant even if the variation of the temperature of the motor occurs. A varying of the resonant frequency can substantially be prevented. The rotational run out of the motor and the noise accompanied therewith can also be reduced.

The bearing device of longer lifetime can be obtained by using balls of ceramic material. This is because the durability of the ceramic material is greater than steel. Thus the motor of longer lifetime of enhanced durability can also be obtained.

In the motor of the structure according to the sixth and seventh aspect of the present invention in which the outer ring member of the bearing device is formed of a pair of first and the second sleeve, the machining operation of the outer raceway on the outer ring member can be effected easily, since each raceway can be formed respectively on each of the first and the second sleeve.

While particular embodiments of the present invention have been illustrated and described, it should be obvious to those skilled in the art that various changes and modifications can be made without departing from the spirit and scope of the invention.

What is claimed is,

1. A motor having a rotating member rotatably supported through a bearing device on a base member of the motor, said bearing device including a shaft, a cylindrical outer ring member surrounding the shaft, and a plurality of balls of the first and the second rows interposed between the shaft and the outer ring member, the bearing device being characterized in that:
the outer ring member includes upper and lower portions and a central portion therebetween,
two rows of outer raceways for the first and the second row of balls are formed on the inner peripheral surface of the upper and lower portions of the outer ring member,
a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion.

2. A motor having a rotating member rotatably supported through a bearing device on a base member of the motor, said bearing device including a shaft to which an inner ring is fit slidably, a cylindrical outer ring member surrounding the shaft, a plurality of balls of the first row interposed between the first inner raceway formed on the outer periphery of the inner ring and the first outer raceway formed on the inner periphery of the outer ring member, a plurality of balls of the second row interposed between the second inner raceway formed directly on the outer periphery of the shaft and the second outer raceway formed on the inner periphery of the outer ring member, the bearing device being characterized in that:
the outer ring member includes upper and lower portions on the inner periphery of which is provided with the first and the second outer raceways respectively and a central portion therebetween,
a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,
wherein the inner ring is secured to the shaft with applying an appropriate pre-load thereon.

3. A motor having a rotating member rotatably supported through a bearing device on a base member of the motor, said bearing device including a shaft, a cylindrical outer ring member surrounding the shaft, and a plurality of balls of the first and the second rows interposed between the shaft and the outer ring member, the bearing device being characterized in that:
the outer ring member includes upper and lower portions and a central portion therebetween,
two rows of outer raceways for the first and the second row of balls are formed on the inner peripheral surface of the upper and lower portions of the outer ring member,
a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,
wherein the shaft is secured on the base member to extend therefrom, and the central portion of the rotor or the rotating member is fit over the outer periphery of the outer ring member.

4. A motor having a rotating member rotatably supported through a bearing device on a base member of the motor, said bearing device including a shaft, an inner ring fit slidably around the shaft, and a cylindrical outer ring member surrounding the shaft, a plurality of balls of the first row interposed between the first inner raceway formed on the outer periphery of the inner ring and the first outer raceway formed on the inner periphery of the outer ring member, and a plurality of balls of the second row interposed between the second inner raceway formed directly on the outer periphery of the shaft and the second outer raceway formed on the inner periphery of the outer ring member, the bearing device being characterized in that:
the outer ring member includes upper and lower portions on the inner periphery of which is provided with the first and the second outer raceways respectively and a central portion therebetween,
a squeeze member of the same material as that used in forming the outer ring member or of any other material of substantially the same coefficient of linear thermal expansion as that of the outer ring member is press fit around the outer periphery of the central portion of the outer ring member to elastically deform the outer ring member inwardly to form an inwardly protruding squeezed portion,
wherein the shaft is secured on the base member to extend therefrom, and the central portion of the rotor or the rotating member is fit over the outer periphery of the outer ring member,
wherein appropriate pre-load is applied to said inner ring.

5. The motor according to any one of claims 1 to 4, characterized in that a thin walled reduced outer diameter portion is formed around the outer periphery of the central portion of the outer ring member of the bearing device, and the squeeze member is press fit around the reduced outer diameter portion.

6. The motor according to any one of claims 1 to 4, characterized in that the outer ring member of the bearing device includes the first and the second sleeve outer rings adjacent axially with each other, each of the first and the second outer raceways is formed on the inner surface of the first and the second sleeve outer rings respectively, thin walled reduced outer diameter stepped portions are formed around adjacent end portions of the first and the second sleeve outer rings, and the squeeze member is press fit around the reduced outer diameter stepped portions.

7. The motor according to any one of claims 1 to 4, characterized in that the outer ring member of the bearing device includes the first and the second sleeve outer rings adjacent axially with each other, each of the first and the second outer raceways is formed on the inner surface of the first and the second sleeve outer rings respectively, thin walled reduced outer diameter stepped portions are formed around adjacent end portions of the first and the second sleeve outer rings, and each of the first and the second squeeze members is press fit around the reduced outer diameter stepped portions respectively.

8. The motor according to claim 1 or 2, characterized in that the squeeze member of the bearing device is a cylindrical body formed on the inner periphery of which with a thick walled reduced inner diameter portion having an inner diameter smaller than the outer diameter of the outer ring member, an axial width of the thick walled portion is smaller than the spacing between two rows of outer raceways, and the outer ring member is pressed by the reduced inner diameter portion of the cylindrical body.

9. The motor according to claims 1 or 2, characterized in that the squeeze member of the bearing device is a cylindrical body formed on the inner periphery of which with a thick walled reduced inner diameter portion having an inner diameter smaller than the outer diameter of the outer ring member, an axial width of the thick walled portion is smaller than the spacing between two rows of outer raceways, and the outer ring member is pressed by the reduced inner diameter portion of the cylindrical body,
wherein the shaft is secured on the base member to extend therefrom, and the central portion of the rotor or the rotating member is fit over the outer periphery of the cylindrical body.

10. The motor according to any one of claims 1 to 4, characterized in that the balls of the bearing device are formed of ceramic material.

11. The motor according to any one of claims 1 to 7, characterized in that the squeeze member is formed of a material lower in its linear thermal expansion than that of the outer ring member.
